(19) United States
(12) Patent Application Publication
(10) Pub. No.: US 2017/0309963 A1
(43) Pub. Date: Oct. 26, 2017

(54) HIGH VOLUMETRIC ENERGY DENSITY LITHIUM BATTERY WITH LONG CYCLE LIFE

(71) Applicant: Dow Global Technologies LLC, Midland, MI (US)

(72) Inventors: Wenjuan Liu, Midland, MI (US); Hideaki Maeda, Tokyo (JP); Koichi Numata, Pearl City, HI (US); Jianxin Ma, Wilmington, DE (US); Yuhua Kao, Shrewsbury, MA (US); Murali Theivanayagam, New Castle, DE (US); Ing-Feng Hu, Midland, MI (US)

(21) Appl. No.: 15/521,247

(22) PCT Filed: Nov. 6, 2015
(86) PCT No.: PCT/US15/59615

§ 371 Date: Apr. 21, 2017

Related U.S. Application Data
(60) Provisional application No. 62/078,265, filed on Nov. 11, 2014.

(51) Int. Cl. H01M 10/0569; H01M 4/505; H01M 4/525; H01M 10/0525; H01M 4/02

(52) U.S. Cl. CPC H01M 10/0569; H01M 4/525; H01M 10/0525; H01M 4/505; H01M 2300/0034; H01M 2300/0037; H01M 2004/028

(57) ABSTRACT

A battery electrolyte solution contains a lithium salt, diethyl carbonate and at least one of 4-fluoroethylene carbonate and ethylene carbonate. This battery electrolyte is highly stable even when used in batteries in which the cathode material has a high operating potential (such as 4.5V or more) relative to Li/Li+. Batteries containing this electrolyte solution therefore have excellent cycling stability.

The present invention relates to lithium batteries.

Lithium batteries are widely used as primary and secondary batteries for vehicles and many types of electronic equipment. These batteries tend to have high energy and power densities and for that reason are favored in many applications.

In principle, one can increase the energy and power density of a battery by increasing its operating voltage. To this end, cathode materials have been developed which have operating potentials of 4.5V or more (vs. Li/Li⁺). However, the higher operating potentials degrade many of the components that are commonly used in lithium battery electrolyte solutions. Ethylene carbonate, for example, is used very widely used as a battery electrolyte solvent in lithium batteries, but is not electrochemically stable at those higher voltages. Electrochemical instability leads to battery performance issues such as capacity fade, voltage fade, poor rate performance, safety, poor high temperature performance and poor high temperature battery life. Therefore, there is a need in the art to develop better-performing high energy density batteries.

This invention is in one aspect an electrical battery comprising an anode, a cathode including a lithium nickel manganese cobalt oxide cathode material, and a separator and a battery electrolyte solution each disposed between the anode and cathode, wherein the battery electrolyte solution includes a lithium salt dissolved in a solvent mixture that includes diethyl carbonate and at least one of 4-fluoroethylene carbonate and ethylene carbonate, wherein the volume ratio of diethyl carbonate to 4-fluoroethylene carbonate and ethylene carbonate is at least 85:15 and the diethyl carbonate, 4-fluoroethylene carbonate and ethylene carbonate together constitute at least 80 volume percent of the solvent mixture.

Batteries of the invention exhibit remarkably high volumetric energy densities. They also exhibit excellent cycling stability. They maintain high voltages and capacities over large numbers of charge/discharge cycles. They exhibit very good performance at high discharge rates, and perform well under high temperature usage and storage conditions.

The cathode includes at least one lithium nickel manganese cobalt oxide cathode material. Suitable lithium nickel manganese cobalt oxide cathode materials include those represented by the formula LiₓNi_{(1-a-b)}MnₐCo_{b}O₂, wherein 0.05≦a≦0.9, 0.05≦b≦0.8, a+b≦0.95 and x is from 1 to 1.4. More preferably, 0.1≦a≦0.5, 0.1≦b≦0.5 and a+b≦0.8; in such embodiments, a+b is less than or equal to 0.6 or less than or equal to 0.4. In some embodiments, x is preferably 1.005 to 1.3, more preferably 1.01 to 1.25 or 1.01 to 1.15.

The cathode material preferably is one having an operating voltage of at least 4.5V vs. Li/Li⁺. The cathode material in some embodiments displays a specific capacity of at least 250 mAh/g when discharged at a rate of 0.05 C from 4.6 volts to 2 volts.

The cathode material may be a lithium nickel manganese cobalt oxide of a type sometimes referred to as a lithium-rich metal oxide or lithium-rich layered oxide (each being identified herein by the acronym LRMO). These materials generally display a layered structure with monoclinic and rhombohedral domains. They may have initial specific discharge capacities of 270 mAh/g or more when charged to a voltage of about 4.6 volts vs. Li/Li^{+.} Suitable LRMO cathode materials include those described in U.S. Pat. Nos. 5,993,998, 6,677,082, 6,680,143, 7,205,072, 7,435,402 and 8,187,752; Japanese Unexamined Pat. No. 11307094A; EP Pat. Appl. No. 1193782; Chem. Mater. 23 (2011) 3614-3621; and J. Electrochem. Soc., 145:12, December 1998 (4160-4168).

The cathode material may also contain small amounts of anionic dopants that improve one or more properties, with an example being fluorine.

The cathode material preferably is supplied in the form of particles having a particle size, as measured using laser methods, of 10 nm to 250 μm, preferably 50 nm to 50 μm.

The cathode may include, in addition to the aforementioned cathode material, one or more additional ingredients such as a binder, conductive particles, a protective coating and the like. The cathode may be formed, for example, by mixing particles of the cathode material with a binder material, a carrier liquid and optionally particles of one or more cathode conductive materials such as carbon black, activated carbon, metals and the like, casting the resulting mixture and then removing the carrier liquid. A protective coating may be applied to the cathode material itself prior to forming the cathode, and/or to the cathode as a whole. The cathode material and/or cathode may be coated with, for example, a non-ionic conductive solid such as, for example, lithium phosphate, lithium sulfide, lithium lanthanum titanate as described in US 2011-0081578, and/or with a coating such as Al₂O₃, La₂O₃ or AlF₃. The cathode may have an etched surface containing stabilizing ammonium phosphorus, titanium, silicon, zirconium, aluminum, boron and/or fluorine atoms as described in US 2007-0281212.

Suitable anode materials include, for example, carbonaceous materials such as natural or artificial graphite, carbonized pitch, carbon fibers, graphitized mesophase microspheres, furnace black, acetylene black and various other graphitized materials. The carbonaceous materials may be bound together using a binder such as a poly(vinylidene fluoride), polytetrafluoroethylene, a styrene-butadiene copolymer, an isoprene rubber, a poly(vinyl acetate), a poly(ethyl methacrylate), polyethylene or nitrocellulose. Suitable carbonaceous anodes and methods for constructing same are described, for example, in U.S. Pat. No. 7,169,511.

Other suitable anode materials include lithium metal, silicon, tin, lithium alloys and other lithium compounds such as lithium titanate.

In preferred embodiments, the anode and cathode material are selected together to provide the battery with an operating voltage of at least 4.5V.

The battery electrodes are each generally in electrical contact with or formed onto a current collector. A suitable current collector for the anode is made of a metal or metal alloy such as copper, a copper alloy, nickel, a nickel alloy, stainless steel and the like. Suitable current collectors for the cathode include those made of aluminum, titanium, tantalum, alloys of two or more of these and the like.

The separator is interposed between the anode and cathode to prevent the anode and cathode from coming into contact with each other and short-circuiting. The separator is conveniently constructed from a nonconductive material. It should not be reactive with or soluble in the electrolyte solution or any of the components of the electrolyte solution under operating conditions. Polymeric separators are generally suitable. Examples of suitable polymers for forming the separator include polyethylene, polypropylene, polybutene-1, poly-3-methylpentene, ethylene-propylene copolymers, polytetrafluoroethylene, polystyrene, polymethylmethacrylate, polydimethylsiloxane, polyethersulfones and the like.

The electrolyte solution must be able to permeate through the separator. For this reason, the separator is generally porous, being in the form of a porous sheet, nonwoven or woven fabric or the like. The porosity of the separator is generally 20% or higher, up to as high as 90%. A preferred porosity is from 30 to 75%. The pores are generally no larger than 0.5 μm, and are preferably up to 0.05 μm, in their longest dimension. The separator is typically at least one μm thick, and may be up to 50 μm thick. A preferred thickness is from 5 to 30 μm.

The battery electrolyte solution includes a lithium salt dissolved in a solvent mixture. The lithium salt may be any that is suitable for battery use, including inorganic lithium salts such as LiAsF₆, LiPF₆, LiB(C₂O₄)₂, LiBF₄, LiBF₂C₂O₄, LiClO₄, LiBrO₄ and LiIO₄ and organic lithium salts such as LiB(C₆H₅)₄, LiCH₃SO₃, LiN(SO₂C₂F₅)₂ and LiCF₃SO₃. LiPF₆, LiClO₄, LiBF₄, LiAsF₆, LiCF₃SO₃ and LiN(SO₂CF₃)₂ are preferred types, and LiPF₆ is an especially preferred lithium salt.

The lithium salt is suitably present in a concentration of at least 0.5 moles/liter of electrolyte solution, preferably at least 1.0 mole/liter, more preferably at least 1.15 moles/liter, up to 3 moles/liter, more preferably up to 1.5 moles/liter and still more preferably up to 1.3 mole/liter. Especially preferred amounts are at least 1.15 moles/liter, especially 1.15 to 1.3 moles/liter. These somewhat high concentrations of lithium salt can enhance the conductivity of the electrolyte solution (compared to lower concentrations), which can compensate for the reduction in conductivity due to the low concentration of ethylene carbonate and high concentration of diethyl carbonate.

The solvent mixture includes diethyl carbonate and at least one of 4-fluoroethylene carbonate and ethylene carbonate, wherein the volume ratio of diethyl carbonate to 4-fluoroethylene carbonate and ethylene carbonate combined is at least 85:15 and the diethyl carbonate, 4-fluoroethylene carbonate and ethylene carbonate together constitute at least 80 volume percent of the solvent mixture. For purposes of this invention, the solvent mixture is considered to include all components of the electrolyte solution except the lithium salt(s).

In a specific embodiment, the solvent mixture contains diethyl carbonate and ethylene carbonate in a volume ratio of 85:15 to 98:2, and the diethyl carbonate and ethylene carbonate together constitute at least 90 volume percent of the solvent mixture. In another specific embodiment, the solvent mixture contains diethyl carbonate and ethylene carbonate in a volume ratio of 93:7 to 98:2, and the diethyl carbonate and ethylene carbonate together constitute at least 90 volume percent of the solvent mixture. In these embodiments, the diethyl carbonate and ethylene carbonate together may constitute at least 95 volume percent or at least 99 volume percent of the solvent mixture, and up to 100 volume percent of the solvent mixture.

In other embodiments, the solvent mixture contains diethyl carbonate and 4-fluoroethylene carbonate in a volume ratio of 85:15 to 98:2, and the diethyl carbonate and ethylene carbonate together constitute at least 90 volume percent of the solvent mixture. In still another embodiment, the solvent mixture contains diethyl carbonate and 4-fluoroethylene carbonate in a volume ratio of 93:7 to 98:2, and the diethyl carbonate and 4-fluoroethylene carbonate together constitute at least 90 volume percent of the solvent mixture. In these embodiments, the diethyl carbonate and 4-fluoroethylene carbonate together may constitute at least 95 volume percent or at least 99 volume percent of the solvent mixture, and up to 100 volume percent of the solvent mixture.

In yet other embodiments, the solvent mixture contains at least 90 volume percent of a mixture of diethyl carbonate, ethylene carbonate and 4-fluoroethylene carbonate. The diethyl carbonate constitutes 85 to 98 percent, preferably 93 to 98 percent, of the combined volume of diethyl carbonate, ethylene carbonate and 4-fluoroethylene carbonate, and the ethylene carbonate and 4-fluoroethylene carbonate together constitute 2 to 15 percent, preferably 2 to 7 percent of the combined volume of diethyl carbonate, ethylene carbonate and 4-fluoroethylene carbonate. The volume ratio of ethylene carbonate to 4-fluoroethylene carbonate in these embodiments can be 1:99 to 99:1. In these embodiments, the diethyl carbonate, ethylene carbonate and 4-fluoroethylene carbonate together may constitute at least 95 volume percent or at least 99 volume percent of the solvent mixture, and up to 100 volume percent of the solvent mixture.

The solvent mixture may include one or more components in addition to the lithium salt diethyl carbonate, ethylene carbonate and 4-fluoroethylene carbonate. These may constitute up to 10 volume percent of the solvent mixture. In some embodiments they constitute no more than 5 volume percent of the solvent mixture and in other embodiments constitute no more than 1 volume percent of the solvent mixture. These additional components may be absent from the solvent mixture.

The additional components may include other solvents for the lithium salt. Examples of such additional solvents include, for example, one or more other linear alkyl carbonates and one or more other cyclic carbonates, as well as various cyclic esters, linear esters, cyclic ethers, alkyl ethers, nitriles, sulfones, sulfolanes, siloxanes and sultones. Mixtures of any two or more of the foregoing types can be used.

Suitable linear alkyl carbonates include dimethyl carbonate, methyl ethyl carbonate and the like. Cyclic carbonates that are suitable include propylene carbonate, butylene carbonate, 3,4-difluoroethylene carbonate and the like. Suitable cyclic esters include, for example, γ-butyrolactone and γ-valerolactone. Cyclic ethers include tetrahydrofuran, 2-methyltetrahydrofuran, tetrahydropyran and the like. Alkyl ethers include dimethoxyethane, diethoxyethane and the like. Nitriles include mononitriles, such as acetonitrile and propionitrile, dinitriles such as glutaronitrile, and their derivatives. Sulfones include symmetric sulfones such as dimethyl sulfone, diethyl sulfone and the like, asymmetric sulfones such as ethyl methyl sulfone, propyl methyl sulfone and the like, and their derivatives. Sulfolanes include tetramethylene sulfolane and the like.

Among the other ingredients that may be present in the battery electrolyte solution are additives which promote the formation of a solid electrolyte interface at the surface of a graphite electrode. Agents that promote solid electrolyte interface (SEI) formation include various polymerizable ethylenically unsaturated compounds, various sulfur compounds, as well as other materials. Examples of polymerizable ethylenically unsaturated compounds are carbonate compounds having aliphatic carbon-carbon unsaturation, such as vinylidine carbonate, vinyl ethyl carbonate, allyl ethyl carbonate and the like. Among the suitable sulfur SEI promoters are sultone compounds, including cyclic sulfonate esters of hydroxyl sulfonic acids. An example of a suitable sultone compound is 1,3-propane sultone.

An advantage of this invention is that SEI-promoting additives are not necessary and can be omitted from the formulation or, if used, used in only small amounts. Thus, in some embodiments, the solvent mixture contains no more than 5 weight-percent, not more than 1 weight-percent, or no more than 0.25 weight-percent of polymerizable ethylenically unsaturated compounds and sulfur-containing compounds.

Still other useful additional ingredients include various cathode protection agents; lithium salt stabilizers; lithium deposition improving agents; ionic solvation enhancers; corrosion inhibitors; wetting agents; flame retardants; and viscosity reducing agents. Many additives of these types are described by Zhang in “A review on electrolyte additives for lithium-ion batteries”, J. Power Sources 162 (2006) 1379-1394. Suitable cathode protection agents include materials such as N,N-diethylaminotrimethylsilane and LiB(C₂O₄)₂. Lithium salt stabilizers include LiF, tris(2,2,2-trifluoroethyl)phosphite, 1-methyl-2-pyrrolidinone, fluorinated carbamate and hexamethylphosphoramide. Examples of lithium deposition improving agents include sulfur dioxide, polysulfides, carbon dioxide, surfactants such as tetraalkylammonium chlorides, lithium and tetraethylammonium salts of perfluorooctanesulfonate, various perfluoropolyethers and the like. Crown ethers can be ionic solvation enhancers, as are various borate, boron and borole compounds. LiB(C₂O₄)₂ and LiF₂C₂O₄ are examples of aluminum corrosion inhibitors. Cyclohexane, trialkyl phosphates and certain carboxylic acid esters are useful as wetting agents and viscosity reducers. Some materials, such as LiB(C₂O₄)₂, may perform multiple functions in the electrolyte solution.

The various other additives, if present, may together constitute, for example, up to 10%, up to 5%, or up to 1% of the total weight of the solvent mixture.

The battery electrolyte solution is preferably nonaqueous. By “nonaqueous”, it is meant the solvent mixture contains less than 500 ppm of water (on a weight basis). A water content of 50 ppm or less is preferred and a more preferred water content is 30 ppm or less. The various components of the battery electrolyte solution can be individually dried before forming the battery electrolyte solution if necessary, and/or the formulated battery electrolyte solution can be dried to remove residual water. The drying method selected should not degrade or decompose the various components of the battery electrolyte solution, nor promote undesired reactions between them. Thermal methods can be used, as can drying agents such as molecular sieves.

The battery electrolyte solution is conveniently prepared by dissolving or dispersing the lithium salt into one or more of the components of the solvent mixture. If the solvent mixture is a combination of materials, the lithium salt can be dissolved into the mixture, any component thereof, or any subcombination of those components. The order of mixing is in general not critical.

The amount of electrolyte solution in the battery may be, for example, up to 20 g/A·h (grams per ampere-hour of cathode capacity) or more. In some embodiments, the amount of electrolyte solution is up to 10 grams per A·h of cathode capacity. In other embodiments, the battery contains 3 to 7, 3 to 6, or 3 to 5 grams of battery electrolyte solution per A·h cathode capacity. Cathode capacity is determined by measuring the specific capacity of the cathode material in a half-cell against a lithium counter-electrode, and multiplying by the weight of cathode material in the cathode.

The battery of the invention can be of any useful construction. A typical battery construction includes the anode and cathode, with the separator and the electrolyte solution interposed between the anode and cathode so that ions can migrate through the electrolyte solution between the anode and the cathode. The assembly is generally packaged into a case. The shape of the battery is not limited. The battery may be a cylindrical type containing spirally-wound sheet electrodes and separators. The battery may be a cylindrical type having an inside-out structure that includes a combination of pellet electrodes and a separator. The battery may be a plate type containing electrodes and a separator that have been superimposed.

The battery is preferably a secondary (rechargeable) lithium battery. In such a battery, the discharge reaction includes a dissolution or delithiation of lithium ions from the anode into the electrolyte solution and concurrent incorporation of lithium ions into the cathode. The charging reaction, conversely, includes an incorporation of lithium ions into the anode from the electrolyte solution. Upon charging, lithium ions are reduced on the anode side, at the same time, lithium ions in the cathode material dissolve into the electrolyte solution.

The battery of the invention can be used in industrial applications such as electric vehicles, hybrid electric vehicles, plug-in hybrid electric vehicles, aerospace, e-bikes, etc. The battery of the invention is also useful for operating a large number of electrical and electronic devices, such as computers, cameras, video cameras, cell phones, PDAs, MP3 and other music players, televisions, toys, video game players, household appliances, power tools, medical devices such as pacemakers and defibrillators, among many others.

The following examples are provided to illustrate the invention, but are not intended to limit the scope thereof. All parts and percentages are by weight unless otherwise indicated.

Battery electrolyte solutions ES-1 through ES-5 and Comparative electrolyte solutions ES-A through ES-D are made by mixing ingredients as indicated in Table 1.

TABLE 1

| Des- | Solvent, Volume-% based on Total Solvents | | | | | | |
|---|---|---|---|---|---|---|---|
| ignation | EC¹ | FEC² | DEC³ | EMC⁴ | DMC⁵ | VC⁶ | Salt |
| ES-1 | 10 | 0 | 90 | 0 | 0 | 0 | 1.2M LiPF₆ |
| ES-2 | 10 | 0 | 90 | 0 | 0 | 0 | 1.0M LiPF₆ |
| ES-3 | 5 | 0 | 95 | 0 | 0 | 0 | 1.2M LiPF₆ |
| ES-4 | 0 | 10 | 90 | 0 | 0 | 0 | 1.0M LiPF₆ |
| ES-5 | 0 | 10 | 90 | 0 | 0 | 0 | 1.2M LiPF₆ |
| ES-6 | 0 | 10 | 90 | 0 | 0 | 0 | 1.3M LiPF₆ |
| ES-7 | 0 | 10 | 90 | 0 | 0 | 0 | 1.4M LiPF₆ |
| ES-8 | 0 | 5 | 95 | 0 | 0 | 0 | 1.2M LiPF₆ |
| Comp. | 50 | 0 | 50 | 0 | 0 | 0 | 1.2M LiPF₆ |
| ES-A* | | | | | | | |
| Comp. | 50 | 0 | 50 | 0 | 0 | 0 | 1.0M LiPF₆ |
| ES-B* | | | | | | | |
| Comp. | 33.3 | 0 | 0 | 33.3 | 33.3 | 0 | 1.0M LiPF₆ |
| ES-C* | | | | | | | |
| Comp. | 32.7 | 0 | 0 | 32.7 | 32.7 | 2 | 1.0M LiPF₆ |
| ES-D* | | | | | | | |

*Not an example of this invention.
¹EC is ethylene carbonate.
²FEC is 4-fluoroethylene carbonate.
³DEC is diethyl carbonate.
⁴EMC is ethyl methyl carbonate.
⁵DMC is dimethyl carbonate.
⁶VC is vinylene carbonate.

The conductivities of each of electrolyte solutions ES-1, ES-3, ES-5 and ES-8 are measured using a conductivity meter with a Pt-coated probe calibrated against electrolytes having different LiPF₆ concentrations in a 50:50 by volume mixture of EC/EMC. The conductivities of these electrolyte solutions are found to be 3.92 mS/cm, 3.17 mS/cm, 4.20 mS/cm and 3.52 mS/cm, respectively. The reduction of conductivity between ES-1 and ES-3, and between ES-5 and ES-8, is in each case believed to be due to the higher concentration of diethyl carbonate, which by itself has a lower conductivity than either ethylene carbonate and 4-fluoroethylene carbonate.

### EXAMPLE 1 AND COMPARATIVE SAMPLES A, B AND C

Duplicate half-cells are made using standard CR2025 parts. The cathode material is an aluminum doped/AlF₃-coated lithium-rich nickel manganese cobalt oxide LRMO material. This material is formed into the cathode by mixing it with polyvinylidene difluoride, vapor grown carbon fiber and conductive carbon black in a 90:5:2.5:2.5 weight ratio, forming a slurry in N-methyl pyrrolidone and coating it onto an etched aluminum current collector. The density of this cathode material in the cathode is about 2.9 g/cc. The anode is lithium. The separator is an aramide separator sold by Teijin. The electrolyte in each case is as indicated in Table 2.

Specific capacity and average voltage are measured by performing an initial charge to 4.6 volts at 0.05 C followed by an initial discharge at 0.05 C to 2 V. The second charge/discharge cycle is at 0.1 C/0.1 C and all subsequent charge/discharge cycles are performed at 0.33 C/1 C, in each case charging to 4.6V and discharging to 2V. The specific capacity after the 8^{th} and the 100th cycles are measured, together with the % loss of specific capacity between the 8^{th} and 100th cycles, are as indicated in Table 2.

TABLE 2

| | | Specific Capacity | | |
|---|---|---|---|---|
| | | 8^{th} Cycle | 90^{th} Cycle | % Capacity |
| Designation | Electrolyte Solution | (mAh/g) | (mAh/g) | loss |
| Ex. 1 | ES-1 | 195 | 175 | 10% |
| Comp. A* | Comp. ES-A | 190 | 140 | 26% |
| Comp. B* | Comp. ES-B | 198 | 125 | 37% |
| Comp. C* | Comp. ES-C | 200 | 135 | 33% |

*Not an example of this invention.

Comp. C represents a baseline case. With this ternary solvent mixture (ethylene carbonate, dimethyl carbonate and ethyl methyl carbonate) and this cathode material, specific capacity fades rapidly with cycling. When the ternary solvent mixture is replaced with a binary solvent mixture (1:1 ethylene carbonate and diethyl carbonate) in Comp. B, results become slightly worse. Increasing the amount of lithium salt as in Comp. A leads to a slight improvement over Comp. B. Reducing the amount of ethylene carbonate to 10 volume percent in Example 1 leads to a large and unexpected improvement in cycling stability. Example 1 loses only about 10% of its initial capacity over 90 cycles on this test.

### EXAMPLES 2-7 AND COMPARATIVE SAMPLE D

Example 2 is made in the same manner as Example 1, except the cathode material is uncoated and undoped lithium-rich nickel manganese cobalt oxide LRMO material. Specific capacity and average voltage are measured by performing an initial charge to 4.6 volts at 0.05 C followed by an initial discharge at 0.05 C to 2 V and then cycling by charging to 4.6 volts and discharging to 2V according to the following protocol:

2^{nd} cycle: charge rate 0.1 C/discharge rate 0.1 C;

3^{rd} cycle: charge rate 0.2 C/discharge rate 0.33 C;

4^{th} cycle: charge rate 0.2 C/discharge rate 1.0 C;

5^{th} cycle: charge rate 0.2 C/discharge rate 3 C;

6^{th} cycle: charge rate 0.2 C/discharge rate 5 C;

7^{th} cycle: charge rate 0.1 C/discharge rate 0.1 C

subsequent cycles: charge rate 0.33 C/discharge rate 1 C with a capacity check at charge/discharge rates of 0.1 C/0.1 C each 25^{th} cycle.

Examples 3-7 and Comparative Sample D are the same as Example 2, except the electrolyte solutions are ES-2, ES-4, ES-5, ES-6, ES-7 and ES-B, respectively. The cells are cycled as before, measuring specific capacity, impedance and average discharge voltage. Results are as indicated in Table 3.

TABLE 3

| Test | Comp. D | Ex. 2 | Ex. 3 | Ex. 4 | Ex. 5 | Ex. 6 | Ex. 7 |
|---|---|---|---|---|---|---|---|
| Electrolyte solvent | ES-B* | ES-1 | ES-2 | ES-4 | ES-5 | ES-6 | ES-7 |
| Specific Capacity, | 246 | 251 | 252 | 245 | 249 | 247 | 240 |
| 8^{th} cycle (mAh/g) | | | | | | | |
| Specific Capacity, | 187 | 235 | 227 | 228 | 231 | 231 | 224 |
| 108^{th} cycle (mAh/g) | | | | | | | |
| Capacity loss, 8^{th}-108^{th} | 24.0 | 6.5 | 9.8 | 7.1 | 7.1 | 6.6 | 6.9 |
| cycles, % | | | | | | | |
| Initial average | 3.512 | 3.519 | 3.517 | 3.507 | 3.517 | 3.517 | 3.518 |
| discharge voltage, | | | | | | | |
| 0.1 C (V) | | | | | | | |
| Initial average | 3.475 | 3.487 | 3.485 | 3.468 | 3.485 | 3.483 | 3.484 |
| discharge voltage, | | | | | | | |
| 1 C (V) | | | | | | | |
| Initial discharge | 0.037 | 0.031 | 0.032 | 0.039 | 0.032 | 0.034 | 0.034 |
| voltage difference | | | | | | | |
| (V) | | | | | | | |
| 107^{th} cycle average | 3.329 | 3.387 | 3.375 | 3.397 | 3.398 | 3.403 | 3.408 |
| discharge voltage, | | | | | | | |
| 0.1 C (V) | | | | | | | |
| 108^{th} cycle average | 3.163 | 3.331 | 3.318 | 3.322 | 3.355 | 3.354 | 3.359 |
| discharge voltage, | | | | | | | |
| 1 C (V) | | | | | | | |
| 100 cycles | 0.166 | 0.056 | 0.057 | 0.075 | 0.044 | 0.049 | 0.048 |
| discharge voltage | | | | | | | |
| difference | | | | | | | |

*Not an example of this invention.

Sample ES-B demonstrates a 24% capacity loss over 100 charge/discharge cycles, whereas the examples of the invention exhibit a capacity loss of below 10% in all instances.

In these experiments, the difference between the average discharge voltage at 0.1 C and 1 C discharge rates taken on consecutive cycles is in indication of internal impedance. With Sample ES-B, this difference rises from 37 to 166 millivolts (Δ129 mV) from the 7^{th}/8^{th} cycle to the 107^{th}/108^{th} cycle. The increase indicates a more than fourfold increase in internal impedance in the cell over 100 charge/discharge cycles, which in turn indicates that the battery electrolyte solution has degraded significantly. With the Examples of the invention, the increase in this difference over 100 charge/discharge cycles ranges from as little as 12 mV to no more than 36 mV. These results show a very large improvement in the stability of the battery and of the electrolyte solution. The absolute values of the average discharge voltages are higher for the examples of the invention.

### EXAMPLES 8 AND 9

Hot-pressed pouch full cells (Examples 8 and 9) are made using the cathode described in Example 1 (2.4 g/cc of cathode material), a graphite anode and a PVDF separator sold by Teijin. In Example 8, the electrolyte solution is ES-1, and in Example 9, the electrolyte solution is ES-5. Specific capacity for each is measured twice, once at room temperature and once at 50° C. The test protocol is to charge to 4.5 V at 0.5 C and discharge to 2V at 1 C. Results are as indicated in Table 4.

TABLE 4

Example No.

| | 8 | 9 |
|---|---|---|
| Initial Specific Capacity, RT (mAh/g) | 202 | 210 |
| Specific Capacity, 30^{th} cycle, RT (mAh/g) | 145 | 180 |
| Initial Specific Capacity, 50° C. (mAh/g) | 202 | 210 |
| Specific Capacity, 30^{th} cycle, 50° C. (mAh/g) | 105 | 170 |

Both batteries exhibit good stability under these test conditions at room temperature. As expected, the batteries are less stable when operated at high temperature. However, Example 9 very surprisingly is nearly as stable when operated at 50° C. than at room temperature operation.

### EXAMPLES 10 AND 11 AND COMPARATIVE SAMPLE E

Li₂CO₃, Ni(OH)₂, Mn₂O₃, and Co₃O₄ particles are mixed simultaneously in a solution of 2% by weight polyacrylic acid in water at a solids loading of about 50% by weight in proportions to provide lithium, nickel, manganese and cobalt at molar ratios of 1.02:0.68:0.16:0.16. The mixture is milled in a Micromedia Bead Mill (PML-2, Buhler Inc. Mahwah, N.J.) loaded with 0.2 to 0.3 mm diameter yittrium stabilized zirconia media (Sigmund Lindner, Germany. SiLibeads® Type ZY premium quality). The mill is run at a power of 1 KW/hour for a sufficient time to obtain a primary particle size (d50) of 0.25 mm. The resulting slurry has a viscosity of about 1600-2000 centipoise measured using a Brookfield Viscometer (Model DV-II+) using a #3 RV Spindle at 22° C.

The slurry is agglomerated by spray drying using a MOBILE MINOR™ 2000 Model H spray dryer (GEA Niro, Denmark) with a feed rate of about 2.4 to 2.8 Kg/hour and a nitrogen flow of 20% 2 SCFM and 1 bar pressure to the atomizer. The inlet temperature is about 180° C. and outlet temperature was about 60 to 65° C. The spray dried agglomerated precursors have a d50 secondary particle size of 12 micrometers. The spray dried agglomerated precursors (50 g) are heated in a static air atmosphere at 890° C. for about 5 hours, followed by 5 hours cooling, to form a cathode material having the approximate formula LiNi_{0.68}Mn_{0.16}Co_{0.16}O₂.

Hot-pressed pouch full cells are made using this cathode material, a graphite anode and a PVDF separator sold by Teijin. The electrolyte solutions for Examples 10 and 11 and Comparative Sample E are ES-1, ES-5 and ES-C, respectively. In these cells, this cathode material has an exceptionally high energy density of about 2500 Wh/L upon charging to 4.4 V at 0.5 C, and about 2430 Wh/L upon charging to 4.35V at 0.5 C. Specific capacity is measured by performing the first 3 charge/discharge cycles at a charge rate of 0.1 C to 4.35 volts followed by discharging at 0.1 C to 2.5 V. Fourth and fifth cycles are performed at charge/discharge rates of 0.5 C/0.5 C and 0.5/2 C, respectively. Cycling performance is then evaluated by performing additional charge/discharge cycles by charging at 1 C to 4.35V followed by discharging at 1 C to 3V at room temperature. The initial specific capacity and number of cycles to 20% capacity loss are as indicated in Table 5.

TABLE 5

| Designation | Ex. 10 | Ex. 11 | Comp. E |
|---|---|---|---|
| Electrolyte solution | ES-1 | ES-5 | ES-C |
| Initial Capacity, mAh/g | 179 | 179 | 179 |
| Cycles to 20% capacity loss | ~450 | ~1000 | ~100 |

This data shows the large and beneficial effect of the battery electrolyte solution of this invention. The rate of capacity loss is reduced to one-fourth to one-tenth that of the control.

1. An electrical battery comprising an anode, a cathode including a lithium nickel manganese cobalt oxide cathode material, and a separator and a battery electrolyte solution each disposed between the anode and cathode, wherein the battery electrolyte solution includes a lithium salt dissolved in a solvent mixture that includes diethyl carbonate and at least one of 4-fluoroethylene carbonate and ethylene carbonate, wherein the volume ratio of diethyl carbonate to 4-fluoroethylene carbonate and ethylene carbonate is at least 85:15 and the diethyl carbonate, 4-fluoroethylene carbonate and ethylene carbonate together constitute at least 80 volume percent of the solvent mixture.

2. The electrical battery of claim 1, wherein the solvent mixture contains diethyl carbonate and ethylene carbonate in a volume ratio of 85:15 to 98:2, and the diethyl carbonate and ethylene carbonate together constitute at least 90 volume percent of the solvent mixture.

3. The electrical battery of claim 2, wherein the solvent mixture contains diethyl carbonate and ethylene carbonate in a volume ratio of 93:7 to 98:2, and the diethyl carbonate and ethylene carbonate together constitute at least 90 volume percent of the solvent mixture.

4. The electrical battery of claim 3, wherein the diethyl carbonate and ethylene carbonate together constitute at least 95 volume percent of the solvent mixture.

5. The electrical battery of claim 4, wherein the diethyl carbonate and ethylene carbonate together constitute at least 99 volume percent of the solvent mixture.

6. The electrical battery of claim 1, wherein the solvent mixture contains diethyl carbonate and 4-fluoroethylene carbonate in a volume ratio of 85:15 to 98:2, and the diethyl carbonate and ethylene carbonate together constitute at least 90 volume percent of the solvent mixture.

7. The electrical battery of claim 6, wherein the solvent mixture contains diethyl carbonate and 4-fluoroethylene carbonate in a volume ratio of 93:7 to 98:2, and the diethyl carbonate and 4-fluoroethylene carbonate together constitute at least 90 volume percent of the solvent mixture.

8. The electrical battery of claim 7, wherein the diethyl carbonate and 4-fluoroethylene carbonate together constitute at least 95 volume percent of the solvent mixture.

9. The electrical battery of claim 8, wherein the diethyl carbonate and 4-fluoroethylene carbonate together constitute at least 95 volume percent of the solvent mixture.

10. The electrical battery of claim 1 wherein the cathode material is represented by the formula LiₓNi_{(1-a-b)}MnₐCo_{b}O₂, wherein 0.2≦a≦0.9, 0.1≦b≦0.8 a+b≦0.95 and x is from 1 to 1.4.

11. The electrical battery of claim 10 wherein the cathode material has an operating potential of at least 4.5V vs. Li/Li⁺.

12. The electrical battery of claim 11 wherein x is 1.01 to 1.15, 0.1≦a≦0.5, 0.1≦b≦0.5 and a+b≦0.4.

13. The electrical battery of claim 1 wherein the concentration of the lithium salt in the battery electrolyte solution is 1.15 to 1.3 moles/liter.

14. The electrical battery of claim 1 which is a secondary lithium battery.

15. The electrical battery of claim 1 wherein the amount of battery electrolyte solution is 3 to 6 g per A·h of cathode capacity.
